(19) United States
(12) Patent Application Publication
(10) Pub. No.: US 2008/0292876 A1
(43) Pub. Date: Nov. 27, 2008

(54) Soft Magnetic Member and Magnetic Device Including the Same

(76) Inventors: Kyung-Ku Choi, Tokyo (JP); Taku Murase, Tokyo (JP)

Correspondence Address: HOGAN & HARTSON L.L.P., 1999 AVENUE OF THE STARS, SUITE 1400, LOS ANGELES, CA, 90067, US

(21) Appl. No.: 10/543,863

(22) PCT Filed: Dec. 16, 2003
(86) PCT No.: PCT/JP2003/016098

§ 371 Date: Apr. 10, 2008

(30) Foreign Application Priority Data
Jan. 29, 2003 (JP) 2003-21071

(51) Int. Cl. B32B 5/00; B32B 15/18

(52) U.S. Cl. 428/336; 428/457

(57) ABSTRACT

There is provided a soft magnetic member comprising a resin film 11 and a soft magnetic layer formed on the resin film 11, the soft magnetic layer comprising a T-L composition layer 7, wherein T is Fe or FeCO, and L is at least one element selected from the group consisting of C, B and N, and a Co based amorphous alloy layer 3 formed on either of the surfaces of the T-L composition layer 7. The Co based amorphous alloy layer 3 is combined with the T-L composition layer 7 to give a magnetic thin film for high frequency simultaneously exhibiting a high permeability and a high saturated magnetization. The magnetic thin film for high frequency can be formed on the resin film 11 because the magnetic thin film can exhibit excellent properties without a high-temperature heat treatment.

### TECHNICAL FIELD

The present invention relates to a soft magnetic member comprising a film and a soft magnetic layer formed on the film, and to a magnetic device, for example, an inductor, including the same soft magnetic member.

### BACKGROUND ART

Recently, there are demands for compactor, more densely packed electronic devices for high frequency, centered by wireless transceivers and handheld terminals. These devices are notably oriented to chip size packages (CSPs) or system on packages (SOPs), as can be seen by developments, e.g., multilayer wiring boards which support electronic parts, e.g., high-frequency choke coil, capacitor and resistor (as disclosed in, e.g., Japanese Patent Laid-Open No. 2002-57467).

Most of inductors built in these multilayer wiring boards comprise an air-core coil. Increasing inductance for these inductors is normally achieved by increasing coil turn number, which, however, is accompanied by several problems, e.g., increase in size of inductors and in DC resistance. Recently, attempts have been made to use magnetic materials for inductors, in order to solve the above problems and, at the same time, to have compactor, higher-capacity inductors to be built in multilayer wiring boards.

Some of the required properties for optimum magnetic materials which can satisfy the above objects include high permeability in a GHz range, and capability of exhibiting the required properties without being heat-treated at high temperature (hereinafter referred to as “high-temperature heat-treatment). However, the magnetic materials exhibiting the above properties have not been realized. It is desirable for a magnetic thin film incorporated in the inductor which is to be built in a multilayer wiring board to be formed on a film, and be transferred onto and laminated (stacked) on the film. However, a conventional magnetic thin film, which has a high residual stress and is prepared by high-temperature heat-treatment, causes a problem of warping of a film on which a magnetic thin film is to be formed. Therefore, a soft magnetic member for high frequency which can be transferred onto and laminated on a film has not been realized.

On the other hand, operating frequency of a large scale integrated circuit (LSI) has increased to 1 GHz or higher, which poses challenges of reducing wiring-caused noise and power consumption. One of the approaches for reducing wiring-caused noise is to decrease distance between the wires, e.g., by locating a passive element immediately below an LSI for connection. However, distance between an LSI chip immediately below an LSI and package is only 100 μm or so for ball grid array (BGA) connection, and a conventional chip type ceramic part cannot cope with this requirement. Therefore, there is need for a technique which can form a thin film or passive part using a supporting member, 50 μm or less in thickness. It is possible to grind a single crystal substrate to a thickness of 50 μm by the advanced semiconductor techniques. Precise grinding, however, is very costly. Therefore, there are demands for techniques which can form a thin film or passive part on a thin, inexpensive film.

The present invention is developed under these situations. It is an object of the present invention to provide a soft magnetic member comprising a magnetic thin film for high frequency formed on a film, wherein the magnetic thin film has a high permeability in a high frequency region of a GHz range and also high saturation magnetization. It is another object of the present invention to provide a magnetic device including the same soft magnetic member.

### DISCLOSURE OF THE INVENTION

The present inventors have found, after having extensively studied to achieve the above objects, that a magnetic thin film for high frequency simultaneously exhibiting high permeability and high saturation magnetization can be realized by a combination of a first layer comprising a T-L composition, wherein T is Fe or FeCo, and L is at least one element selected from the group consisting of C, B and N, and a second layer comprising a Co based amorphous alloy and disposed on either of the surfaces of the first layer. This magnetic thin film for high frequency can exhibit good properties without high-temperature heat-treatment, and hence can be formed on a film. Thus, the present invention provides a soft magnetic member comprising a film and a soft magnetic layer formed on the film, wherein the soft magnetic layer comprises a first layer comprising a T-L composition, wherein T is Fe or FeCo, and L is at least one element selected from the group consisting of C, B and N, and a second layer comprising a Co based amorphous alloy and disposed on either of the surfaces of the first layer. The soft magnetic layer in the soft magnetic member of the present invention may comprise a plurality of the first layers and a plurality of the second layers alternately laminated to form a multilayer film structure.

It is important for the soft magnetic member of the present invention to have an amorphous structure for the first layer comprising a T-L composition. As described earlier, a conventional magnetic thin film causes a problem of warping of a film on which it is to be formed, because of its high residual stress and being prepared by high-temperature heat-treatment or the like. The inventors of the present invention have found, after having extensively studied to realize a magnetic thin film which has a reduced residual stress and causes no warping of a film on which it is to be formed, that residual stress in the magnetic thin film can be very effectively reduced, when the first layer, as well as the second layer, has an amorphous structure.

It is preferable to select FeCo as T for the soft magnetic member of the present invention, because FeCo can give the soft magnetic member a higher saturation magnetization. When FeCo is used as T, it preferably has a Co content of 20 to 50 at %.

Moreover, it is preferable to select C and/or B as L. In this case, L may be contained at 2 to 20 at %.

The second layer for the soft magnetic member of the present invention comprises Co as the main component and may contain at least one element selected from the group consisting of B, C, Si, Ti, V, Cr, Mn, Fe, Ni, Y, Zr, Nb, Mo, Hf, Ta and W.

In the soft magnetic member of the present invention, the first layer can have an amorphous structure when its thickness T1 is set within the range of 0.5 to 3.0 nm.

It is preferable that a T1/T2 ratio is within the range of 0.8 to 3.0, where T2 is thickness of the second layer.

The soft magnetic member of the present invention can exhibit the following excellent properties; the soft magnetic member has a real part (μ′) of complex permeability at 1 GHz of 400 or more, a quality factor Q (μ′/μ″) of 10 or more, and a saturation magnetization of 14 kG (1.4 T) or more. Moreover, in the present invention, these properties can be obtained from the as deposited soft magnetic member. In other words, the judgment as to whether the soft magnetic member concerned has properties defined in the present invention can be made on the basis of the value measured under the condition that a treatment such as a heat treatment is not applied after the completion of the deposition, the time elapsed from the completion of the deposition having nothing to do with this judgment. However, even when a treatment such as a heat treatment, except high-temperature heat-treatment which may cause film deformation, is applied after the completion of the deposition, the soft magnetic member concerned having the properties defined in the present invention, needless to say, falls within the scope of the present invention. This statement is similarly applicable to any member of the present invention, described below.

A resin film is suitable as the film, described above.

The present invention also provides a soft magnetic member comprising a resin film and a soft magnetic layer formed on the resin film, characterized in that the soft magnetic layer is constituted by alternately laminating first layers each comprising Fe or FeCo as the main component and having an amorphous structure, and second layers each comprising Co as the main component and having an amorphous structure. Alternately laminating the first layers each comprising Fe or FeCo as the main component and the second layers each comprising Co as the main component can simultaneously realizing a high permeability and a high saturation magnetization. An excessive stress can be prevented from being applied to the resin film, when both of the first and second layers have an amorphous structure. Therefore, no warping of the resin film occurs in the soft magnetic member of the present invention, even after the soft magnetic layer is formed on the resin film. Accordingly, it is preferable that a total thickness of the soft magnetic layer is set at 200 to 2000 nm in the soft magnetic member of the present invention.

The soft magnetic member of the present invention has a saturation magnetization of 15 kG (1.5 T) or more.

Moreover, the soft magnetic member of the present invention can also have a resistivity of 10 to 1000 μΩcm.

The present invention also provides a magnetic device including a soft magnetic member for high frequency which contains a film and a soft magnetic amorphous metal layer formed on the film, characterized in that the soft magnetic amorphous metal layer comprises a first layer comprising a T-L composition, wherein T is Fe or FeCo, and L is at least one element selected from the group consisting of C, B and N; and a second layer comprising a Co based amorphous alloy and deposited on either of the surfaces of the first layer; wherein a plurality of the first layers and a plurality of the second layers are laminated to form a multilayer film. The magnetic device of the present invention may be an inductor, transformer or the like. More specifically, it may be a magnetic device having magnetic thin films for high frequency, facing each other to hold a coil in-between; inductor for hybrid microwave integrated circuits; and inductor for chip size packages.

The film in the magnetic device of the present invention has a thickness of preferably 10 to 200 μm, more preferably 50 μm or less.

The above-described soft magnetic, amorphous, metal layer preferably has a real part (μ′) of complex permeability at 1 GHz of 400 or more, and a saturation magnetization of 14 kG (1.4 T) or more.

### BRIEF DESCRIPTION OF THE DRAWINGS

FIG. 1 is a cross-sectional view schematically illustrating the soft magnetic member of the present invention;

FIG. 2 shows X-ray diffraction analysis results of composite magnetic thin films, each of which is a laminate of Fe—C thin film (thickness T1: 3.0 nm or less) and amorphous alloy thin film of CoZrNb;

FIG. 3 is a cross-sectional view schematically illustrating crystal grain conditions of a Fe- or FeCo-based thin film;

FIG. 4 schematically illustrates a Fe—C thin film (thickness: 50 nm) formed on a substrate;

FIG. 5 is a plan view illustrating an example of inductor to which the magnetic thin film for high frequency according to one embodiment of the invention is applied;

FIG. 6 is a cross-sectional view of the inductor shown in FIG. 5 along the A-A line;

FIG. 7 is a cross-sectional view illustrating another example of inductor to which the magnetic thin film for high frequency according to one embodiment of the invention is applied;

FIG. 8 is a plan view illustrating an example of inductor to which the soft magnetic member of the present invention is applied;

FIG. 9 is a cross-sectional view of the inductor shown in FIG. 8 along the A-A line;

FIG. 10 is a cross-sectional view schematically illustrating the soft magnetic member, taken out into air after being prepared by deposition;

FIG. 11 shows a magnetization curve of the sample prepared in Example 1;

FIG. 12 shows a high-frequency permeability characteristic curve of the sample prepared in Example 1;

FIG. 13 shows a magnetization curve of the sample prepared in Example 2;

FIG. 14 shows a high-frequency permeability characteristic curve of the sample prepared in Example 2;

FIG. 15 shows a magnetization curve of the sample prepared in Example 3;

FIG. 16 shows a high-frequency permeability characteristic curve of the sample prepared in Example 3;

FIG. 17 is a cross-sectional view schematically illustrating the sample prepared in Comparative Example 1;

FIG. 18 is a cross-sectional view also schematically illustrating the sample prepared in Comparative Example 1;

FIG. 19 summarizes the magnetic properties and the like, analyzed for the composite magnetic thin films prepared in Examples 1 to 9; and

FIG. 20 summarizes the magnetic properties and the like, analyzed for the composite magnetic thin films prepared in Examples 10 to 14.

### BEST MODE FOR CARRYING OUT THE INVENTION

The embodiments of the present invention will be described below.

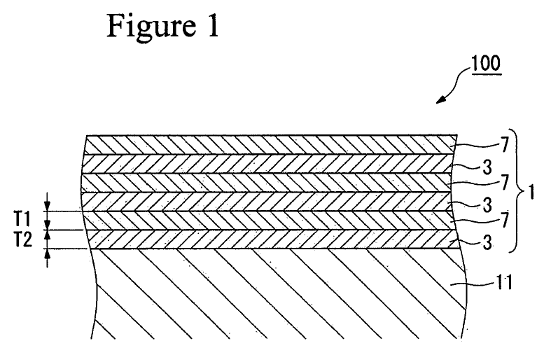

FIG. 1 is a cross-sectional view schematically illustrating the soft magnetic member of the present invention.

Referring to FIG. 1, a soft magnetic member 100 of the present invention comprises a resin film (film) 11 and a magnetic thin film for high frequency (soft magnetic layer) 1 formed on the resin film 11. The magnetic thin film for high frequency 1 has a multilayer film structure in which a plurality of Co based amorphous alloy layers (second layers) 3 and a plurality of T-L composition layers (first layers) 7 are alternately laminated. That is, the magnetic thin film 1 is a composite magnetic thin film. The embodiment illustrated in FIG. 1 is the magnetic thin film for high frequency 1 having a multilayer film structure with a total of 6 layers.

First, the T-L composition layer 7 is described.

As shown in FIG. 1, the T-L composition layer 7 is disposed on one surface of the Co based amorphous alloy layer 3. In the T-L composition layer 7, T stands for Fe or FeCo, and L for at least one element selected from the group consisting of C, B and N. A thin film comprising Fe or FeCo as the main component tends to have a high coercive force and low resistivity, although exhibiting a high saturation magnetization. Therefore, it is incorporated for the present invention with at least one element, represented by L, which is selected from the group consisting of C, B and N capable of improving soft magnetic properties.

The T-L composition layer 7 for the present invention contains the element L (at least one element selected from the group consisting of C, B and N) at 2 to 20 at %, preferably 4 to 10 at %. At below 2 at %, the columnar crystal of the bcc structure tends to grow perpendicularly to the substrate to increase coercive force and decrease resistivity, making it difficult to secure good high frequency properties. At above 20 at %, on the other hand, resonance frequency decreases resulting from decreased anisotropic magnetic field, making it difficult for the thin film for high frequency to fully exhibit its functions.

T is more preferably FeCo, because it can give a higher saturation magnetization than Fe. The Co content may be adequately set in a range of 80 at % or less, preferably 20 to 50 at %. The composition may be incorporated with one or more elements other than Fe or FeCo within limits not harmful to the present invention.

The T-L composition layer 7 preferably has a thickness T1 within the range of 0.5 to 3.0 nm. The T-L composition layer 7 can have an amorphous structure, when its thickness T1 is set at 3.0 nm or less. The T-L composition layer 7 can have improved soft magnetic properties and a high electric resistance, when it retains an amorphous structure. The thickness T1 can be decreased to 0.2 nm without deteriorating the layer functions. However, excessively decreasing the thickness T1 causes production-related problems resulting from an increased number of laminating operations to extend the deposition time. Therefore, the thickness T1 is preferably 0.5 nm or more, more preferably 1.0 nm or more. The T-L composition layer 7 preferably has by itself a saturation magnetization of 1.6 T or more, in order to find effects in high-frequency properties.

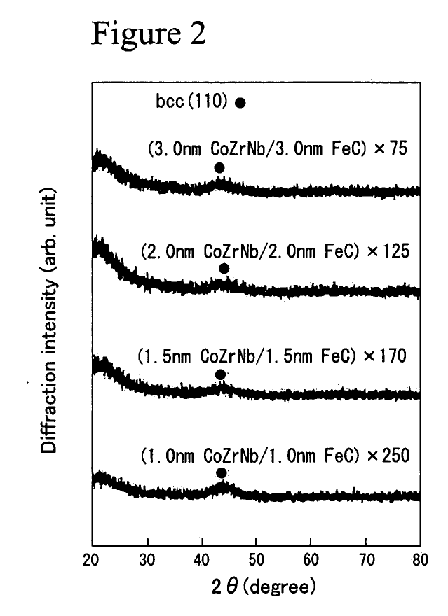

FIG. 2 shows the X-ray diffraction results of a composite magnetic thin film in which Fe—C thin films of 3 nm or less in the thickness T1 and CoZrNb amorphous alloy thin films are laminated. As can be seen from FIG. 2, the laminates, in which the thickness of each of the Fe—C thin films is 3 nm or less, each exhibit a diffraction peak of the bcc (110) crystal plane of the Fe—C system having a typical broad shape for an amorphous system.

Next, the Co based amorphous alloy layer 3 is described.

A Co based amorphous alloy is characterized by having high permeability and high resistance (resistivity: 100 to 150 μΩcm), and can effectively suppress an eddy current loss in a high frequency range. A Co based alloy has other characteristics, e.g., taking an amorphous structure more easily than other alloys, low magnetostriction and high oxidation resistance. Therefore, the present invention adopts a Co based amorphous alloy for the second layer which comes into contact with the T-L composition layer 7 as the first layer. The Co based amorphous alloy layer 3 preferably has by itself permeability, measured at a frequency of 10 MHz: 1000 or more, saturation magnetization: 10 kG (1.0 T) or more, and resistivity: 100 μΩcm or more.

When the second layer is made of an amorphous material, even if a columnar structure is present in places in the first layer (e.g., when the first layer has a thickness of above 3.0 nm), the growth of the columnar structure is blocked by the second layer, failing in forming continuous columnar structure. The presence of a continuous columnar structure is undesirable, because it may increase residual stress to apply an excessive stress to the resin film 11.

The Co based amorphous alloy layer 3 as the second layer for the present invention comprises Co as the main component and at least one additional component selected from the group consisting of B, C, Si, Ti, V, Cr, Mn, Fe, Ni, Y, Zr, Nb, Mo, Hf, Ta and W. The Co based amorphous alloy layer 3 is mainly composed of an amorphous phase. It may be incorporated with one or more additional components, described above, normally at 5 to 50 at %, preferably 10 to 30 at % (as a total content when 2 or more components are incorporated). The presence of the additional component(s) beyond the above range may cause problems, e.g., saturation magnetization may be insufficient at an excessively high content, and difficulty in controlling magnetostriction and hence in securing effective soft magnetic properties at an excessively low content.

The suitable compositions for the Co based amorphous alloy layer 3 include CoZr, CoHf, CoNb, CoMo, CoZrNb, CoZrTa, CoFeZr, CoFeNb, CoTiNb, CoZrMo, CoFeB, CoZrNbMo, CoZrMoNi, CoFeZrB, CoFeSiB and CoZrCrMo.

The magnetic thin film for high frequency 1 can simultaneously exhibit high permeability and high saturation magnetization by a combination of the T-L composition layer 7 and Co based amorphous alloy layer 3 disposed on either of the surfaces of the layer 7, for the following reasons.

The magnetic thin film for high frequency 1 of the present invention is suitably used in a high frequency range of several hundreds MHz or higher, in particular in a GHz range of 1 GHz or higher more. Permeability in such a high frequency range (hereinafter simply referred to as “high-frequency permeability”) is a property related to various properties of samples in a complex manner, particularly closely to anisotropic magnetic field and saturation magnetization. Roughly speaking, product of permeability and resonance frequency is in proportion to anisotropic magnetic field to the 1/2^{th} power and to saturation magnetization to the 3/2^{th} power. Resonance frequency is given by the formula (I)

fᵣ=(γ/2π)[Hₖ4πMₛ]^{1/2} formula (1)

wherein, fᵣ is resonance frequency, γ is gyro magnetic constant, Hₖ is anisotropic magnetic field and 4πMₛ is saturation magnetization.

It is therefore possible to increase resonance frequency and hence allowable upper limit of frequency by increasing anisotropic magnetic field or saturation magnetization of a material. The formula (1) is used to estimate an anisotropic magnetic field required to increase resonance frequency to 2 GHz for a CoZrNb amorphous alloy thin film as a typical example of conventional Co based amorphous alloy thin film. The required anisotropic magnetic field is 44 Oe (3501 A/m) or more. This means that it is difficult to apply the film, which normally has an anisotropic magnetic field of 15 Oe (1193 A/m) or so, to a GHz-order frequency range. On the other hand, anisotropic magnetic field required to realize a resonance frequency of 2 GHz is 36 Oe (2864 A/m) when saturation magnetization is 14 kG (1.4 T), and 28 Oe (2228 A/m) when it is 18 kG (1.8 T). It is therefore expected to realize the required saturation magnetization and anisotropic magnetic field, when combined with a Fe- or FeCo-based alloy, which is known to have a high saturation magnetization and magnetic crystalline anisotropy.

An alloy with Fe or FeCo as the main component has been widely known as a material of high saturation magnetization. However, a magnetic thin film of Fe- or FeCo-based alloy, when prepared by deposition, e.g., sputtering, is difficult to realize good high-frequency properties, because of its high coercive force and low resistivity, although exhibiting a high saturation magnetization. Conceivably, this is mainly due to the following reasons. Referring to FIG. 3, a Fe- or FeCo-based thin film 101, prepared by deposition (e.g., sputtering), has a columnar structure growing perpendicularly to a substrate 301. This causes problems resulting from the perpendicular magnetic anisotropy produced by the columnar structure. In addition, when the thin resin film 11 is used in place of the substrate 301, the columnar structure causes other problems, because it produces a residual stress which may greatly warp the resin film 11.

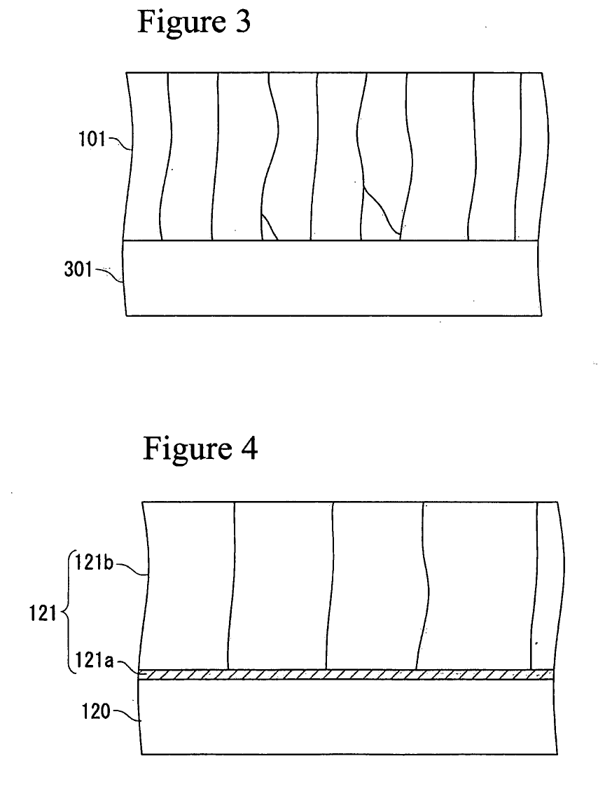

However, the inventors have found, after having extensively studied, that a Fe—C thin film, Fe is incorporated with carbon (C) at a given content, can have an amorphous structure, when its thickness is controlled at a given level. More specifically, they have found, after having studied the growth process of a Fe—C thin film in detail, that the microcrystalline condition is retained with crystals having a grain size of 3 nm or less during the initial stage of film growth in which thickness of the film increases up to around 3 nm. They have also found that the film shows an amorphous feature, because of increased proportion of unstable surfaces. This is illustrated by referring to FIG. 4.

FIG. 4 schematically illustrates a Fe—C thin film 121 (thickness: 50 nm) formed on a substrate 120. In the condition shown in FIG. 4, the Fe—C thin film 121 is composed of a amorphous structure 121a formed on the substrate 120 and columnar structure 121b formed on the amorphous structure 121a. Being amorphous may be judged for the case of the Fe—C thin film, on the basis of the X-ray diffraction, from the absence of the diffraction peak ascribable to the Fe—C bcc (110) crystal plane. A thin film having such amorphous structure, needless to say, does not turn into columnar structure, and can yield high resistance (100 μΩcm or more) property attributable to amorphous structure. In addition, residual stress, which mainly results from a columnar structure, can be reduced in the above thin film. Accordingly, adoption of a form in which the Fe—C thin films and the Co based amorphous alloy thin films are laminated makes it possible to actualize soft magnetic properties, needless to say, and a high resistance, so that a magnetic thin film high in permeability in the GHz range, suppressed in eddy current loss and high in quality factor can be obtained. Setting thickness of the Fe—C thin film in such a way to have an amorphous structure throughout the magnetic thin film will prevent an excessive stress from being applied to the resin film 11, even when thin resin film 11 replaces the substrate 120. This allows a magnetic thin film of excellent properties to be formed on the resin film 11 while preventing its warping. Warping of the resin film 11 causes undesirable effects, e.g., difficulty in using the soft magnetic member 100 as a thin inductor, and in transferring or laminating the soft magnetic member 100.

Effectiveness of laminating of a Fe—C thin film and Co based amorphous alloy thin film is described by taking a Fe—C thin film as an example. However, the effectiveness can be realized with a FeCo—C thin film instead of Fe—C thin film, where C may be substituted by B or N.

As discussed above, the magnetic thin film can simultaneously have a high permeability and saturation magnetization by disposing the Co based amorphous alloy layer 3 of excellent soft magnetic properties on either surface of the T-L composition layer 7 having a high saturation magnetization and anisotropic magnetic field. Moreover, a magnetic thin film having a high permeability and saturation magnetization can be also formed on the resin film 11. In other words, the soft magnetic member 100 of excellent properties, comprising the resin film 11 and a magnetic thin film, can be realized.

More specifically, alternately laminating the T-L composition layer 7 and Co based amorphous alloy layer 3 can give the magnetic thin film for high frequency 1 having the following properties, real part (μ′) of complex permeability at 1 GHz: 400 or more, quality factor Q (μ′/μ″): 10 or more and saturation magnetization: 14 kG (1.4 T) or more. Moreover, it can have a high resistivity of 130 μΩcm while keeping the excellent magnetic properties, described above. The magnetic thin film preferably has as high a real part (μ′) of complex permeability at 1 GHz as possible. There is no upper limit. Similarly, the magnetic thin film preferably has as high a saturation magnetization as possible. There is no upper limit. Also, there is no upper limit of resistivity. However, it is preferably set at around 1000 μΩcm or less, because excessively high resistivity may deteriorate soft magnetic properties and high saturation magnetization properties.

Thickness T1 of the T-L composition layer 7 is set at 3.0 nm or less (not including 0), preferably 0.5 to 3.0 nm, in order to secure the above properties. Evolution of a columnar structure can be suppressed in the layer 7 having a thickness in the above range, as discussed earlier. As a result, the problems caused by a columnar structure can be solved, to secure satisfactory soft magnetic properties.

It is preferable to simultaneously keep T1 within the range of 0.5 to 3.0 nm and T1/T2 ratio within the range of 0.8 to 3.0, where T2 is thickness of the Co based amorphous alloy layer 3. At a T1/T2 ratio above 3.0, the Fe—C crystal grains may grow excessively, making it difficult to secure a high resistivity of 130 μΩcm or more, and, at the same time, it may be difficult to secure high soft magnetic properties, because of insufficient proportion of the Co based amorphous alloy layer 3. At a T1/T2 ratio below 0.8, on the other hand, it may be difficult to keep resonance frequency at a high level, because of insufficient proportion of the T-L composition layer 7, which has a high saturation magnetization. The preferable T1/T2 ratio is 1.0 to 3.0, more preferably 1.0 to 2.5. Keeping the T1 and T1/T2 levels each in the above range for the present invention can realize the composite thin film having the following very excellent properties; resistivity: 130 μΩcm or more, real part (μ′) of complex permeability at 1 GHz: 400 or more, quality factor Q (μ′/μ″) 10 or more, and saturation magnetization: 14 kG (1.4 T) or more. These properties can be measured on the as-deposited film not applied a treatment such as a heat treatment, as described earlier.

A total number of laminating operations for the T-L composition layers 7 and Co based amorphous alloy layers 3 is not limited for the soft magnetic member 100 of the present invention, comprising the magnetic thin film for high frequency 1 formed on the resin film 11. However, it is normally around 5 to 3000, preferably 10 to 700. The same type of films (i.e., T-L composition layers 7 or Co based amorphous alloy layers 3) normally have the same thickness in the magnetic thin film for high frequency 1. However, in some rare cases, it is possible that even the same type films in a particular laminating portion are made to be different in deposition thickness from the same type films in other laminating portions depending on the laminating portions. In an extreme case, for example, the T-L composition layer 7 at around the center may be 20 nm thick and those of the upper and lower ends may be 5 nm thick. In this case, film thickness of the T-L composition layer 7 for the present invention may be given by the arithmetic average (Tf). In the above example, by adopting a value Tf=10 nm as an arithmetic average value, Tf/Tc, where Tc is an arithmetic average film thickness of the Co based amorphous alloy layer 3, may be obtained, for example. Moreover, the magnetic thin film for high frequency 1 of the present invention may include one or more layers other than the Co based amorphous alloy layers 3 and T-L composition layers 7.

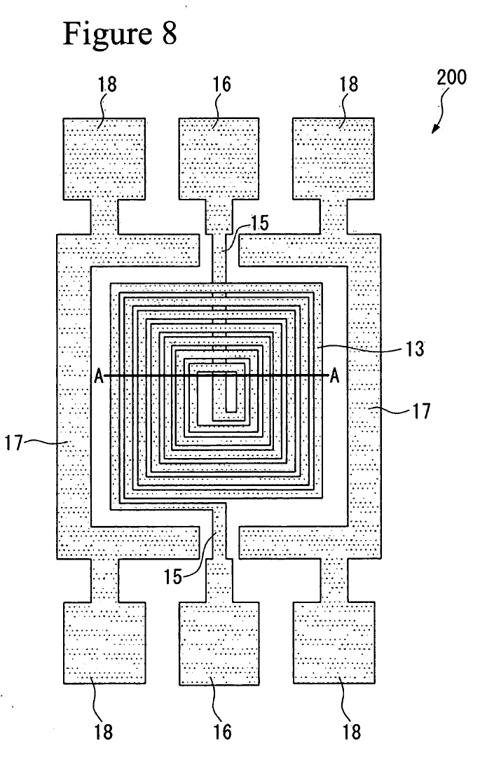

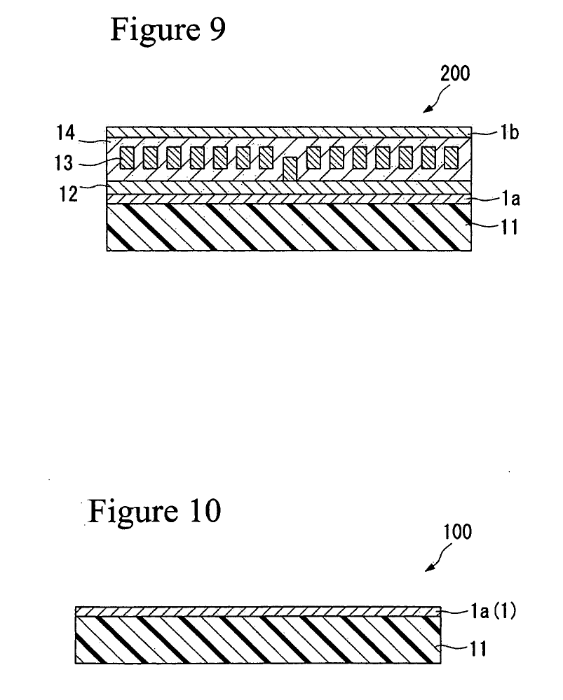

The magnetic thin film for high frequency 1 of the present invention is 200 to 2000 nm thick, preferably 300 to 1000 nm thick. The film 1 having a thickness below 200 nm may have problems resulting from difficulty in generating a required power, when applied to a planar magnetic device. Moreover, it may have problems when applied to a cored coil equipped with a magnetic thin film, later described (refer to FIGS. 8 and 9), because it may have an inductance increase limited to below 10% when compared with an inductor having air core structure, with the result that the magnetic thin film may not fully exhibit its effects. When the thickness is above 2000 nm, on the other hand, the magnetic thin film may have problems resulting from notably increased high frequency loss by the skin effect to increase loss in a GHz range.

The magnetic thin film for high frequency 1 of the present invention is preferably produced by a vacuum thin film formation process, in particular sputtering. More specifically, it can be produced by sputtering, e.g., RF sputtering, DC sputtering, magnetron sputtering, ion beam sputtering, induction-coupled RF plasma-assisted sputtering, ECR sputtering, faced-targets sputtering, or simultaneous multiple sputtering.

The target for producing the Co based amorphous alloy layer 3 may be a composite target with pellets incorporated with a desired additive element, placed on a Co target. The target may be made of a Co alloy incorporated with a desired additive component.

The target for producing the T-L composition layer 7 may be a composite target with pellets of an element L placed on a Fe (or FeCo alloy) target, or an alloyed target of Fe (or FeCo) and element L. The concentration regulation for the element L may be made, for example, by regulating the amount of the pellets of the element L.

It may be noted that the sputtering is merely one mode of the present invention, and needless to say, other thin film formation processes may be applicable. As for the specific deposition method for the magnetic thin film for high frequency 1 of the present invention, Examples to be described later may be referred to.

Next, the resin film 11, on which the magnetic thin film for high frequency 1 is formed as illustrated in FIG. 1, is described.

The preferable resin film 11 on which the magnetic thin film for high frequency 1 of the present invention is formed as illustrated in FIG. 1 may be selected from plastic films of fluorinated resin, e.g., those of polytetrafluoroethylene, tetrafluoroethylene/hexafluoropropylene copolymer, tetrafluoroethylene/perfluoroalkylvinyl ether copolymer, tetrafluoroethylene/ethylene copolymer, polychlorotrifluoroethylene, polyvinylidene fluoride and polyvinyl fluoride. Moreover, known plastic films are also useful for the resin film 11. These films include those of polyethylene, polypropylene, polystyrene, polyvinyl chloride, polyester, polycarbonate, polyimide, polysulfone, polyether sulfone, polyamide, polyamideimide, polyetherketone and polyphenylene sulfide. Of these, films of polyethylene terephthalate (PET), biaxially oriented polypropylene (OPP), methylpentene copolymer (PTX), and fluorinated resin are more preferable. The preferable fluorinated resin films include those of ethylene fluoride (1F), ethylene trifluoride (3F) and ethylene tetrafluoride (4F).

The resin film 11 is around 10 to 200 μm thick, preferably 15 to 150 μm thick.

The soft magnetic member 100 of the present invention has very excellent high-frequency properties, exhibiting its functions in the as-deposited condition after it is produced by deposition carried out at room temperature, as described earlier. As such, it can be suitably used for hybrid microwave integrated circuits, multilayer wiring boards and, in particular, as an inductor for chip size packages.

Next, specific examples of the magnetic device to which the magnetic thin film for high frequency 1 of the present invention is applied are described.

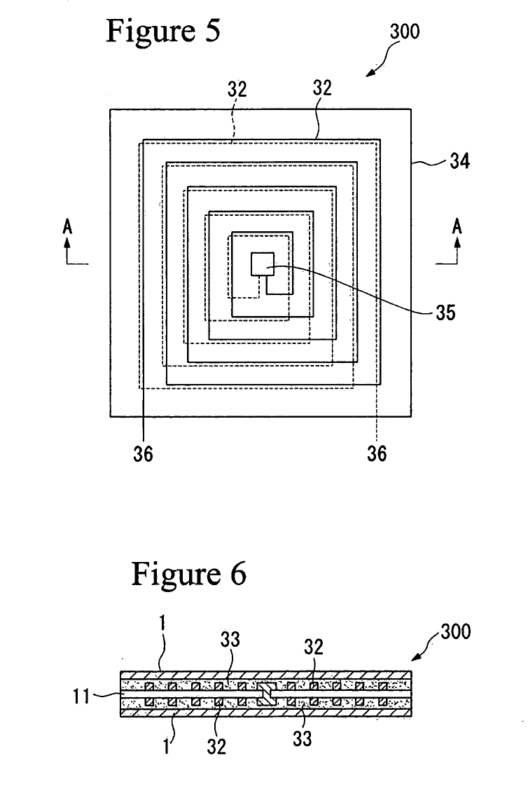

FIGS. 5 and 6 show a planar magnetic device applied to an inductor, where FIG. 5 is a plan view schematically illustrating the inductor, and FIG. 6 is a cross-sectional view of the inductor shown in FIG. 5 along the A-A line.

The inductor (magnetic device) 300 comprises the resin film 11, planar coils 32, 32 spirally formed on both sides of the film 11, insulating films 33, 33 formed to cover the coils 32, 32 and film 11, and a pair of the magnetic thin film for high frequency 1 of the present invention, formed to cover each of the insulating films 33, 33. Additionally, the two above described planar coils 32, 32 are electrically connected to each other through the intermediary of a through hole 35 formed in an approximately central location on the resin film 11. Furthermore, from the planar coils 32, 32 on both surfaces of the resin film 11, terminals 36 for connection are extended to the outside of the resin film 11. Such an inductor 30 is constituted in such a way that a pair of the magnetic thin films 1 for high frequency sandwich the planar coils 32, 32 through the intermediary of the insulating films 33, 33, so that an inductor is formed between the connection terminals 36, 36.

The inductor formed in this way is small and thin in shape and light in weight, and exhibits excellent inductance particularly in the high frequency range of 1 GHz or above.

Additionally, in the above described inductor 300, a transformer can be formed by arranging a plurality of the planar coils 32 in a parallel manner.

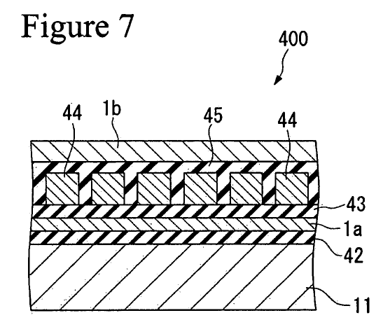

FIG. 7 shows another preferred embodiment in which the planar magnetic device of the present invention is applied to an inductor. FIG. 7 schematically shows a cross-sectional view of the inductor. As shown in FIG. 7, an inductor (magnetic device) 400 comprises a resin film 11, an oxide film 42 formed according to need on the resin film 11, a magnetic thin film for high frequency (soft magnetic layer) 1a of the present invention formed on the oxide film 42, and an insulating film 43 formed on the magnetic thin film for high frequency 1a, and furthermore, has a planar coil 44 formed on the insulating film 43, an insulating film 45 formed so as to cover the planar coil 44 and the insulating film 43, and a magnetic thin film for high frequency (soft magnetic layer) 1b of the present invention formed on the insulating film 45. The inductor 400 formed in this way is also small and thin in shape and light in weight, and exhibits excellent inductance particularly in the high frequency range of 1 GHz or above. Additionally, in the inductor 400 as described above, a transformer can be formed by arranging a plurality of the planar coils 44 in a parallel manner.

In this connection, the planar magnetic devices such as the thin film inductors are demanded to provide the optimal permeability according to the design specifications for respective devices. The permeability in the high frequency range is highly correlated with the anisotropic magnetic field, and is proportional to the reciprocal of the anisotropic magnetic field. For the purpose of actualizing high permeability in the high frequency range, it is necessary that the magnetic thin film has an in-plane uniaxial magnetic anisotropy. In the planar magnetic devices such as the thin film inductors, it can be expected that the higher is the saturation magnetization of a magnetic thin film, the more the DC superposition properties are improved. Consequently, the magnitude of the saturation magnetization can be said to be an important parameter in the design of the magnetic thin film for high frequency 1.

Next, a specific example of the magnetic device to which the soft magnetic member 100 of the present invention is applied is described.

FIGS. 8 and 9 show an example of inductor to which a planar magnetic device is applied, where the inductor is designed for a monolithic microwave integrated circuit (MMIC) FIG. 8 is a schematic plan view showing the conductor layer portion extracted from the inductor, and FIG. 9 is a schematic sectional view along the A-A line in FIG. 8.

An inductor (magnetic device) 200 illustrated by these figures comprises, a resin film 11, a magnetic thin film for high frequency 1a formed on the resin film 11, an insulating film 12 formed on the magnetic thin film for high frequency 1a, and furthermore, has a spiral coil 13 formed on the insulating film 12, an insulating film 14 formed so as to cover the spiral coil 13 and the insulating film 12, and a magnetic thin film for high frequency 1b of the present invention formed on the insulating film 14. Additionally, the spiral coil 13 is connected to a pair of electrodes 16 through the intermediary of the wires 15. A pair of ground patterns 17 arranged so as to surround the spiral coil 13 are respectively connected to a pair of ground electrodes 18, thus forming a shape in which the frequency properties are evaluated on a wafer by means of a ground-signal-ground (G-S-G) type probe.

The inductor 200 of this embodiment has a cored structure with the spiral coil 13 held between the magnetic thin films for high frequency 1a and 1b, each serving as the magnetic core. This inductor has at least 50% higher inductance than that of air core structure with no magnetic thin films 1a and 1b for high frequency, although having the spiral coil 13 of the same shape. Therefore, it can realize the same inductance by the spiral coil 13 occupying a smaller space, by which is meant that the spiral coil 13 can be compactor and higher in capacity. In this embodiment, total thickness of the device, including the resin film 11, can be controlled within the range of about 45 to 180 μm (e.g., resin film 11 thickness: 15 to 150 μm, magnetic thin film for high frequency 1a thickness: 0.5 μm, insulating film 12 thickness: 10 μm, insulating film 14 thickness: 10 μm, and magnetic thin film for high frequency 1b thickness: 0.5 μm).

### EXAMPLES

Next, the present invention is described in more detail by specific examples.

### Example 1

The magnetic thin film for high frequency of the present invention was prepared by the following deposition procedure.

A 50 μm thick polyethylene terephthalate (PET) film was used as the resin film 11 as a substrate, shown in FIG. 1.

The magnetic thin film for high frequency was deposited on a substrate by the following procedure using a faced-targets sputtering apparatus. The faced-targets sputtering apparatus was preliminarily evacuated to 8×10⁻⁵ Pa, into which an Ar gas was introduced until the pressure of the interior reached 10 Pa. Then, the resin film surface was etched by sputtering for 10 minutes at an RF power of 100 W. Then, a CO₈₇Zr₅Nb₈ target and composite target with carbon pellets on a Fe target were alternately sputtered at a power of 300 W, while an Ar gas was introduced at a rate controlled to keep inside pressure at 0.4 Pa, to deposit a composite magnetic thin film as the magnetic thin film for high frequency 1, formed according to the specifications to be described later.

A DC bias of −40 to −80 V was applied to the resin film 11 working as a substrate during the deposition process. Pre-sputtering was carried out with a shutter closed for 10 minutes or more, to prevent adverse effects by impurities present on the target surface. Then, the shutter was opened to deposit the layers on the resin film 11, at a rate of 0.33 nm/second for the CoZrNb layer and 0.27 nm/second for the Fe—C layer. Shutter opening/closing time was controlled to adjust thickness of these layers to be alternately laminated. The resin film 11 was first coated with the CoZrNb layer as the first layer, then with the Fe—C layer, and with these layers alternately one by one in this order. Temperature of the resin film 11 was not controlled during the deposition process. It increased to 30° C., when these layers were deposited to a total thickness of 500 nm.

250, 1.0 nm thick CoZrNb layers and 250, 1.0 nm thick Fe—C layers (carbon content: 5 at %) were alternately laminated one by one to a total thickness of 500 nm (a total of 500 layers), to prepare the composite magnetic thin film of the present invention (sample prepared in Example 1). FIG. 10 is a cross-sectional view schematically illustrating the soft magnetic member 100, taken out into air after completion of the deposition process. The resin film 11 constituting the soft magnetic member 100 retained a flat surface even after it was coated with the magnetic thin film for high frequency 1, as well as before. It could be easily cut by scissors into pieces of required size for analysis of physical properties.

Structure of the composite magnetic film was confirmed by X-ray diffraction and transmission electron microscopy. No reflection from the crystal plane was observed, confirming that both of the Fe—C and CoZrNb layers constituting the composite magnetic film were amorphous. The reason why no reflection from the crystal plane was observed, is conceivably that thickness of the Fe—C layer was set at 1.0 nm and grain growths in the Fe—C layer were controlled by the CoZrNb layer.

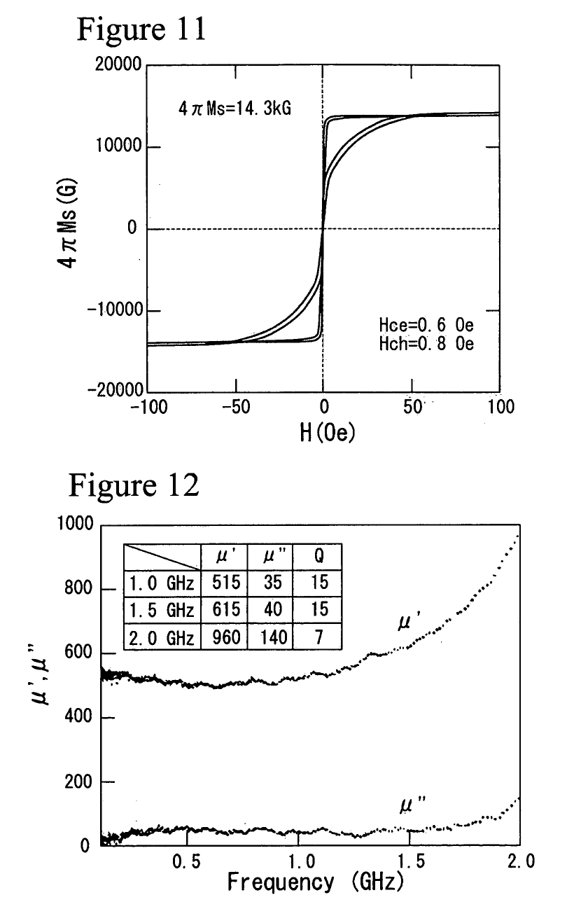

FIG. 11 shows a magnetization curve of the as-deposited composite magnetic film. As shown, in-plane uniaxial magnetic anisotropy was observed in the laminated film, which exhibited the following properties, saturation magnetization: 14.3 kG (1.43 T), coercive force along the axis of easy magnetization: 0.6 Oe (47 A/m) and coercive force along the axis of hard magnetization: 0.8 Oe (63 A/m).

FIG. 12 shows a high-frequency permeability characteristic curve of the composite magnetic thin film. As shown, its resonance frequency exceeded the measuring limit of 2 GHZ, indicating that its real part (μ′) of complex permeability was 500 or more in a GHz range. Moreover, its quality factor Q (μ′/μ″) was 15 at 1 GHz and 7 at 2 GHz. High-frequency permeability was measured by an analyzer (Naruse Kagaku Kiki, PHF-F1000) for high-frequency permeability of thin films, and magnetic properties by vibrating sample magnetometer (Riken Denshi, BHV-35). Its resistivity was 150 μΩcm, determined by a 4-probe resistor (MICROSWISS, equipped with a 4-probe head, NPS, Σ-5). The magnetic properties and resistivity were measured in the same manner in other Examples, described below.

### Example 2

170, 1.5 nm thick CoZrNb layers and 170, 1.5 nm thick Fe—C layers (carbon content: 5 at %) were alternately laminated one by one to a total thickness of 510 nm (a total of 340 layers) by the procedure described in Example 1, to prepare the composite magnetic thin film of the present invention (sample prepared in Example 2).

Structure of the composite magnetic film was confirmed by X-ray diffraction and transmission electron microscopy. No reflection from the crystal plane was observed, confirming that both of the Fe—C and CoZrNb layers constituting the composite magnetic film were amorphous.

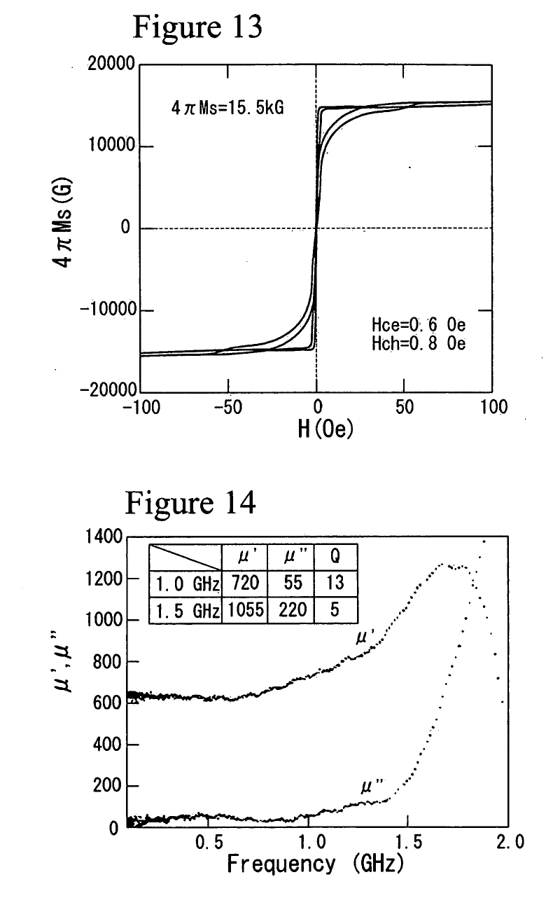

FIG. 13 shows a magnetization curve of the as-deposited composite magnetic film. As shown, in-plane uniaxial magnetic anisotropy was observed in the laminated film, which exhibited the following properties, saturation magnetization: 15.5 kG (1.55 T), coercive force along the axis of easy magnetization: 0.6 Oe (47 A/m) and coercive force along the axis of hard magnetization: 0.8 Oe (63 A/m).

FIG. 14 shows a high-frequency permeability characteristic curve of the composite magnetic thin film. As shown, it had a real part (μ′) of complex permeability of 720 at 1 GHz and 1055 at 1.5 GHz, and a quality factor Q (μ′/μ″) of 13 at 1 GHz and 5 at 1.5 GHz. Its resistivity was 130 μΩcm.

### Example 3

170, 1.0 nm thick CoZrNb layers and 170, 2.0 nm thick Fe—C layers (carbon content: 5 at %) were alternately laminated one by one to a total thickness of 510 nm (a total of 340 layers) by the procedure described in Example 1, to prepare the composite magnetic thin film of the present invention (sample prepared in Example 3).

Structure of the composite magnetic film was confirmed by X-ray diffraction and transmission electron microscopy. No reflection from the crystal plane was observed, confirming that both of the Fe—C and CoZrNb layers constituting the composite magnetic film were amorphous.

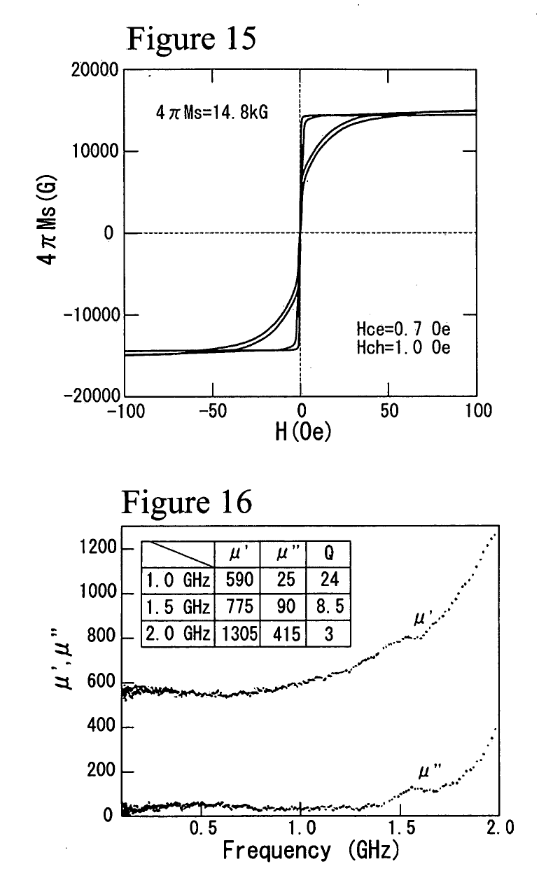

FIG. 15 shows a magnetization curve of the as-deposited composite magnetic film. As shown, in-plane uniaxial magnetic anisotropy was observed in the laminated film, which exhibited the following properties, saturation magnetization: 14.8 kG (1.48 T), coercive force along the axis of easy magnetization: 0.7 Oe (55 A/m) and coercive force along the axis of hard magnetization: 1.0 Oe (79 A/m).

FIG. 16 shows a high-frequency permeability characteristic curve of the composite magnetic thin film. As shown, it had a real part (μ′) of complex permeability of 500 or more at 1 GHz and 775 at 1.5 GHz, and a quality factor Q (μ′/μ″) of 24 at 1 GHz and 8.5 at 1.5 GHz. Its resistivity was 145 μΩcm.

### Comparative Example 1

A 500 nm thick magnetic thin film (sample prepared in Comparative Example 1) was prepared in the same manner as in Example 1, except that it comprised 500 nm thick Fe—C layers only, in place of the 500 nm thick composite magnetic thin film.

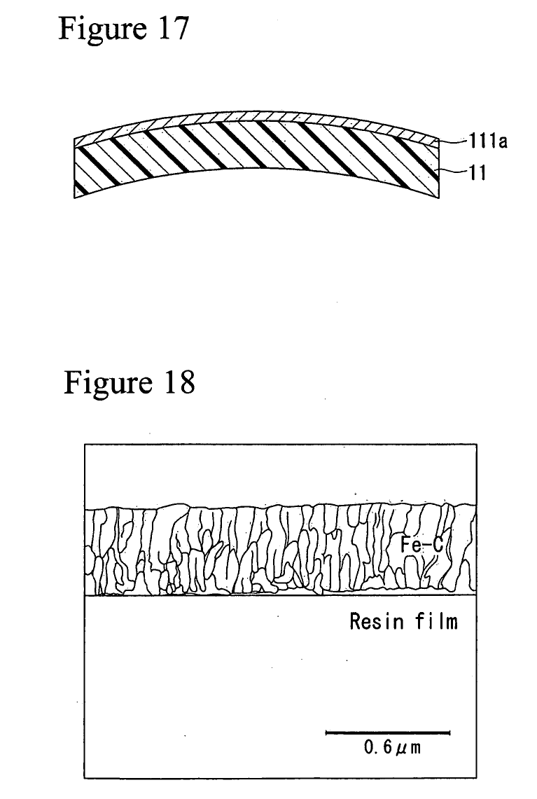

FIG. 17 shows a cross-sectional view schematically illustrating the magnetic thin film. As shown, the resin film 11 on which the magnetic thin film 111a is formed was greatly deformed, and difficult to analyze physical properties. FIG. 18 is a cross-sectional view of the magnetic thin film 111a based on a transmission electron microgram. As shown, the Fe—C layer mainly comprised columnar grains, indicating that residual stress was produced as a result of growth of the columnar structure to cause the warping.

### Example 4

The composite magnetic thin film of the present invention (sample prepared in Example 4) was prepared in the same manner as in Example 1, except that CO₈₇Zr₅Nb₈ as the Co based amorphous alloy layer composition was replaced by CO₈₉Zr₆Ta₅.

### Example 5

The composite magnetic thin film of the present invention (sample prepared in Example 5) was prepared in the same manner as in Example 1, except that CO₈₇Zr₅Nb₈ as the Co based amorphous alloy layer composition was replaced by CO₈₀Fe₉Zr₃B₈.

### Example 6

The composite magnetic thin film of the present invention (sample prepared in Example 6) was prepared in the same manner as in Example 1, except that the Fe—C layer was replaced by a Fe—B layer, where a Fe₉₅B₅ alloy target was used to form the Fe—B layer.

### Example 7

The composite magnetic thin film of the present invention (sample prepared in Example 7) was prepared in the same manner as in Example 1, except that the Fe—C layer was replaced by a Fe—B—N layer, where a Fe₉₅B₅ alloy target was used and a nitrogen gas was introduced into the sputtering chamber during the sputtering process to form the Fe—B—N layer.

### Example 8

The composite magnetic thin film of the present invention (sample prepared in Example 8) was prepared in the same manner as in Example 1, except that the Fe—C layer was replaced by a Fe—B—C layer, where a Fe₉₅B₅ alloy target was used to form the Fe—B—C layer.

### Example 9

The composite magnetic thin film of the present invention (sample prepared in Example 9) was prepared in the same manner as in Example 1, except that the Fe—C layer was replaced by a Fe—C—N layer, where a nitrogen gas was introduced into the sputtering chamber during the sputtering process to form the Fe—C—N layer.

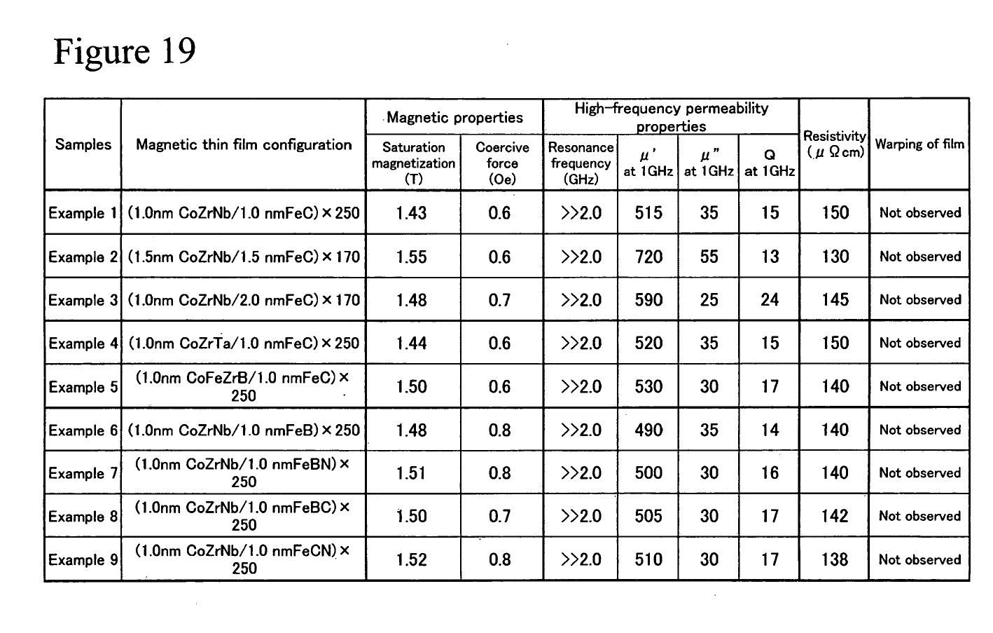

Each of the composite magnetic thin films prepared in Examples 4 to 9 was analyzed for its magnetic and high-frequency permeability properties, and resistivity. Whether the resin film 11 was warped or not was also observed visually. The results are summarized in FIG. 19, which also shows the properties of the films prepared in Examples 1 to 3 for comparison.

As shown in Examples 4 to 9 of FIG. 19, B and/or N can be included as well as C for the film which constitutes the T-L composition layer 7.

### Example 10

The composite magnetic thin film of the present invention (sample prepared in Example 10) was prepared in the same manner as in Example 1, except that the Fe—C layer was replaced by a FeCo—C layer, where a composite target of Fe₇₀CO₃₀ coated with carbon pellets was used to form the FeCo—C layer.

### Example 11

The composite magnetic thin film of the present invention (sample prepared in Example 11) was prepared in the same manner as in Example 1, except that the Fe—C layer was replaced by a FeCo—B layer, where a Fe₆₅CO₃₀B₅ alloy target was used to form the FeCo—B layer.

### Example 12

The composite magnetic thin film of the present invention (sample prepared in Example 12) was prepared in the same manner as in Example 1, except that the Fe—C layer was replaced by a FeCo—B—N layer, where a Fe₆₅CO₃₀B₅ alloy target was used and a nitrogen gas was introduced into the sputtering chamber during the sputtering process to form the FeCo—B—N layer.

### Example 13

The composite magnetic thin film of the present invention (sample prepared in Example 13) was prepared in the same manner as in Example 1, except that the Fe—C layer was replaced by a FeCo—B—C layer, where a composite target of Fe₆₅CO₃₀B₅ alloy coated with carbon pellets was used to form the FeCo—B—C layer.

### Example 14

The composite magnetic thin film of the present invention (sample prepared in Example 14) was prepared in the same manner as in Example 1, except that the Fe—C layer was replaced by a FeCo—C—N layer, where a composite target of Fe₇₀CO₃₀ coated with carbon pellets was used and a nitrogen gas was introduced into the sputtering chamber during the sputtering process to form the FeCo—C—N layer.

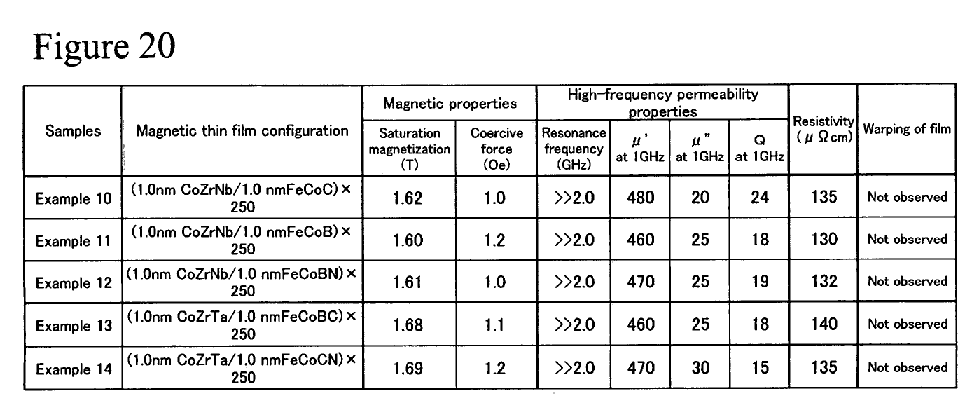

Each of the composite magnetic thin films prepared in Examples 10 to 14 was analyzed for its magnetic and high-frequency permeability properties, and resistivity. Whether the resin film 11 was warped or not was also observed visually. The results are summarized in FIG. 20. Analysis conditions of its magnetic and high-frequency permeability properties and resistivity were the same as the above.

As shown in Examples 10 to 14 of FIG. 20, FeCo is also effective as T for the T-L composition layer 7. It is noted that each of the films prepared in Examples 10 to 14 has a saturation magnetization of 16 kG (1.60 T) or more. It is therefore confirmed that employment of FeCo as T for the T-L composition layer 7 is particularly effective for improving its magnetic properties.

### INDUSTRIAL APPLICABILITY

The present invention can provide a soft magnetic member comprising a magnetic thin film for high frequency having a high permeability in a high frequency GHz range and also a high saturation magnetization formed on a film. The present invention can also provide a magnetic device including the same soft magnetic member.

1. A soft magnetic member comprising
a film and
a soft magnetic layer formed on said film, characterized in that
said soft magnetic layer comprises
a first layer comprising a T-L composition, wherein T is Fe or FeCo, and L is at least one element selected from the group consisting of C, B and N, and
a second layer comprising a Co based amorphous alloy and disposed on either of the surfaces of said first layer.

2. The soft magnetic member according to claim 1, characterized in that said soft magnetic layer comprises a plurality of said first layers and a plurality of said second layers alternately laminated to form a multilayer film structure.

3. The soft magnetic member according to claim 1 or 2, characterized in that said first layer has an amorphous structure.

4. The soft magnetic member according to claim 1, characterized in that said T is FeCo which contains Co at 20 to 50 at %.

5. The soft magnetic member according to claim 4, characterized in that said L is C and/or B.

6. The soft magnetic member according to claim 1, characterized in that said L is contained at 2 to 20 at %.

7. The soft magnetic member according to claim 1, characterized in that said second layer comprises Co as the main component and at least one element selected from the group consisting of B, C, Si, Ti, V, Cr, Mn, Fe, Ni, Y, Zr, Nb, Mo, Hf, Ta and W.

8. The soft magnetic member according to claim 7, characterized in that Co is contained at 5 to 80 at %.

9. The soft magnetic member according to claim 1, characterized in that said first layer has a thickness T1 set within the range of 0.5 to 3.0 nm.

10. The soft magnetic member according to claim 9, characterized in that the ratio of the first layer thickness T1 to the second layer thickness T2, i.e., T1/T2 ratio, is within the range of 0.8 to 3.0, where T2 is a thickness of said second layer.

11. The soft magnetic member according to claim 1, characterized in that said soft magnetic member has a real part (μ′) of complex permeability at 1 GHz of 400 or more, a quality factor Q (μ′/μ″) of 10 or more, and a saturation magnetization of 14 kG (1.4 T) or more.

12. The soft magnetic member according to claim 1 or 2, characterized in that said film is a resin film.

13. A soft magnetic member comprising
a resin film and
a soft magnetic layer formed on said resin film, characterized in that
said soft magnetic layer is constituted by alternately laminating
first layers each comprising Fe or FeCo as the main component and having an amorphous structure, and
second layers each comprising Co as the main component and having an amorphous structure.

14. The soft magnetic member according to claim 13, characterized in that said soft magnetic layer has a total thickness of 200 to 2000 nm.

15. The soft magnetic member according to claim 13, characterized in that said soft magnetic member has a saturation magnetization of 15 kG (1.5 T) or more.

16. The soft magnetic member according to claim 13, characterized in that said soft magnetic member has a resistivity of 10 to 1000 μΩcm.

17. A magnetic device including a soft magnetic member for high frequency, characterized in that
said soft magnetic member for high frequency comprises
a film and
a soft magnetic amorphous metal layer formed on said film comprising:
a first layer comprising a T-L composition, wherein T is Fe or FeCo, and L is at least one element selected from the group consisting of C, B and N; and
a second layer comprising a Co based amorphous alloy and deposited on either of the surfaces of said first layer;
wherein a plurality of said first layers and a plurality of said second layers are laminated to form a multilayer film.

18. The magnetic device according to claim 17, characterized in that said film has a thickness of 10 to 200 μm.

19. The magnetic device according to claim 18, characterized in that said film has a thickness of 50 μm or less.

20. The magnetic device according to claim 17, characterized in that said soft magnetic amorphous metal layer has a real part (μ′) of complex permeability at 1 GHz of 400 or more, and a saturation magnetization of 14 kG (1.4 T) or more.
